(19) United States
(12) Patent Application Publication
(10) Pub. No.: US 2008/0290730 A1
(43) Pub. Date: Nov. 27, 2008

(54) Flyback Converter

(75) Inventors: Paul Johannes Marie Julicher, Eindhoven (NL); Pieter Jan Mark Smidt, Eindhoven (NL); Fatmir Ribari, Eindhoven (NL); Franciscus Bernardus Marie Van Horck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,788

(22) PCT Filed: Apr. 6, 2005
(86) PCT No.: PCT/IB05/51131

§ 371 Date: Oct. 10, 2006

(30) Foreign Application Priority Data
Apr. 13, 2004 (EP) 04101490.3

(51) Int. Cl. H02M 3/335

(52) U.S. Cl. 307/31

(57) ABSTRACT

The present invention relates to a multiple output flyback converter having a switch regulated output circuit (5). To avoid a second communication interval, due an output voltage in this secondary controlled output that is lower what is implied by its number of winding turns, the inductance of this circuit is increased. This can preferably be done by increasing the leakage inductance of the winding (6) in the regulated circuit.

### FIELD OF THE INVENTION

The present invention relates to a flyback converter, comprising a primary side input circuit, having a primary winding wound on a transformer and a primary switch element in series with the primary winding, a first output circuit, having a first secondary winding, wound on the transformer and connected in series with a rectifying element and a secondary switch element, and at least a second output circuit, having a second secondary winding, wound on the transformer and connected in series with a rectifying element.

### BACKGROUND OF THE INVENTION

A DC/DC converter of the above mentioned type is disclosed e.g. in EP, 0772284 A2. Such a device, having a switched secondary control arrangement, allows the output of the first secondary output circuit to be accurately regulated to a desired value, without the use of a high dissipation linear control circuit.

One problem associated with the converter of the above mentioned type is that, even if the dissipation in the secondary output circuit is considerably lower than if a linear control circuit were used, the dissipation is still quite high.

### SUMMARY OF THE INVENTION

It is therefore an object of the present invention to provide a converter of the above mentioned type with lower dissipation.

This object is achieved by means of a flyback converter according to claim 1.

More specifically, the invention according to one aspect relates to a flyback converter, comprising a primary side input circuit, having a primary winding wound on a transformer and a primary switch element in series with the primary winding, a first output circuit, having a first secondary winding, wound on the transformer and connected in series with a rectifying element and a secondary switch element, and at least a second output circuit, having a second secondary winding, wound on the transformer and connected in series with a rectifying element, wherein said first output circuit comprises means for increasing the inductance in the first output circuit.

By increasing the inductance, the RMS current and hence the dissipation can be kept lower. This is because the increased inductance limits the rate of the rise of the current in the first secondary winding. The increased inductance alters the current distribution in such a way, that the peak current in the first secondary winding is limited. Since the peak current is lowered, the secondary control keeps the switch conducting for a longer period of time as to control the output voltage. Therefore, the resulting current waveform has a significantly lower RMS value. Moreover, second commutations, where the first and second output circuit begin their flyback strokes at different instants can be avoided to a great extent. Thus the increase of the inductance is particularly advantageous in cases where otherwise second commutations could occur.

In a preferred embodiment, the means for increasing the inductance in the first output circuit comprises means for increasing the leakage inductance of the first secondary winding. This is an inexpensive solution, since no extra component need be added.

Preferably, the first secondary winding is primarily wound around a first leg of the transformer and the means for increasing the leakage inductance of the first secondary winding comprises at least one turn in the first secondary winding enclosing a second leg of the transformer.

Alternatively, the means for increasing the leakage inductance of the first secondary winding comprises a gap between the primary winding and the first secondary winding.

Alternatively, the means for increasing the inductance in the first secondary output circuit may comprise an auxiliary inductance, connected in series with the first secondary winding, and a freewheeling diode, for allowing a current to continue to flow through the auxiliary inductance when the secondary switch is opened.

In a preferred embodiment, the converter may further comprise control means for variably controlling the output of the first secondary output circuit. Together with the increased inductance, the control means allows the provision of a variable voltage within a certain range, without the risk of introducing a second commutation interval in the circuit.

These and other aspects of the invention will be apparent from and elucidated with reference to the embodiments described hereinafter.

### BRIEF DESCRIPTION OF THE DRAWINGS

FIG. 1 illustrates schematically a flyback converter with switched secondary side control according to the prior art.

FIG. 2 illustrates waveforms in the flyback converter of FIG. 1 in a first situation.

FIG. 3 illustrates waveforms in the flyback converter of FIG. 1 in a second situation.

FIG. 4 illustrates a flyback converter, modified in accordance with an embodiment of the invention.

FIG. 5 shows an arrangement for increasing the leakage inductance of a winding.

FIG. 6 shows another arrangement for increasing the leakage inductance of a winding.

FIG. 7 illustrates an alternative method for increasing the inductance in an output circuit.

FIG. 8 illustrates a preferred embodiment of the invention where so called half turns are added to a transformer winding.

FIGS. 9 and 10 illustrate oscilloscope images for a converter with a conventional transformer.

FIGS. 11 and 12 illustrate a corresponding measurement performed on a converter according to an embodiment of the invention, comprising so called half turns for increasing the leakage inductances in the switch regulated output circuits.

FIGS. 13 and 14 illustrate an RMS current comparison at full load between a converter with a conventional transformer and a converter according to an embodiment of the invention.

### DESCRIPTION OF PREFERRED EMBODIMENTS

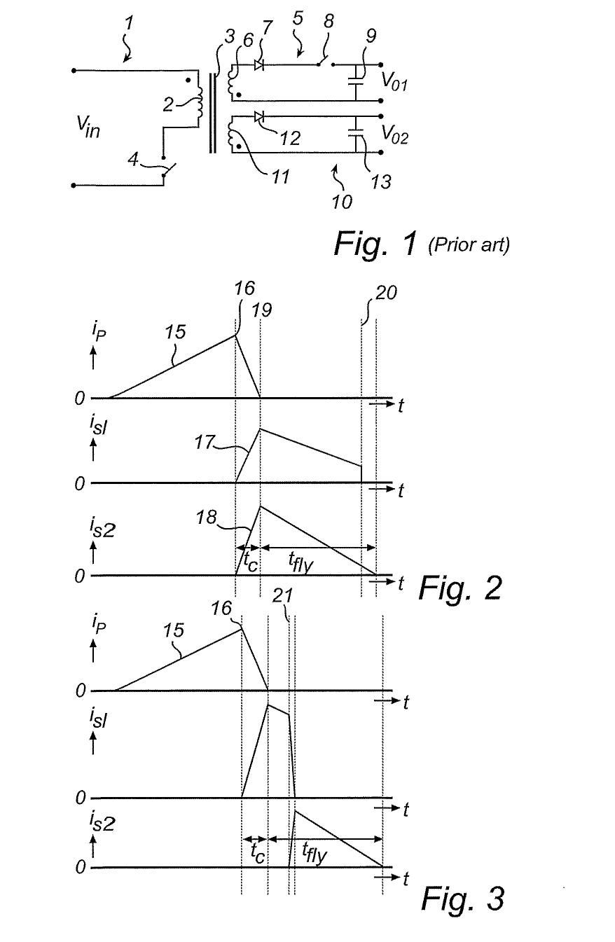

FIG. 1 illustrates schematically a flyback converter with switched secondary side control according to the prior art. A flyback converter provides galvanic insulation between the input side and the output side, and can simultaneously deliver multiple different output voltages at its secondary side. Flyback converters may be found in numerous consumer electronics products, such as television sets, DVD players and -recorders, satellite receivers, etc.

As described in EP 0772284 A2 one output circuit may be provided with a switched secondary side regulator, which allows one output voltage to be precisely regulated to a predetermined desired value, without the use of a high dissipation linear regulator.

Such a flyback converter comprises a primary side input circuit 1, comprising a primary winding 2 wound on a transformer 3 and a primary switch element 4, such as a MOSFET, in series with the primary winding 2. The input circuit 1 receives an input voltage Vᵢₙ. The switch 4 is switched on and off to allow energy transport from the primary side to the secondary side of the transformer 3 as will be described later. Several control technologies, such as normal PWM (Pulse Width Modulation) or self-oscillating methods, may be used to control the switch 4 in order to regulate the total amount of energy that flows from the input side to the outputs of the converter.

The converter further comprises a first output circuit 5, comprising a secondary winding 6, with n₁ turns, wound on the transformer 3 and connected in series with a rectifying element 7, in the form of a diode, and a secondary switch element 8, such as, again, a MOSFET. The secondary switch 8 serves to accurately control the output voltage of the first output circuit, as will be described later. The first secondary output circuit 5 further comprises an output capacitor 9 across which the output voltage V₀₁ is generated.

The converter further comprises a second output circuit 10, which is not regulated by means of a secondary side switch. It should be noted that more than one such circuit may be present in the converter. The second output circuit 10 comprises a secondary winding 11, with n₂ turns, wound on the transformer 3 and connected in series with a rectifying element 12, such as a diode. The second output circuit 10 further comprises an output capacitor 13, corresponding to the output capacitor in the first output circuit 5. The second output circuit provides the voltage V₀₂. The voltage Vₒ₂ may be regulated by controlling the operation of the primary side switch 4.

FIG. 2 illustrates waveforms in the flyback converter of FIG. 1 in a first situation. From top to bottom there is illustrated the current iₚ of the primary side input circuit 1, the current iₛ₁ of the first secondary output circuit 5, and the current iₛ₂ of the second secondary output circuit 10.

During a first phase in the switching cycle, the primary switch element 4 is closed and iₚ rises 15 at a rate depending on both the inductance of the primary winding 2 and the input voltage Vᵢₙ. Then the primary side switch element 4 switches off at a first point of time 16 and a commutation takes place (during t_{c}) where the secondary side currents iₛ₁, iₛ₂ simultaneously rise 17, 18 whereafter a flyback stroke begins at a second point of time 19. During the flyback stroke (t_{fly}), the energy stored in the transformer 3 during the first phase is delivered to the secondary side circuits 5, 10. The current iₛ₁ in the first circuit 5 is cut of by the secondary side switch element 8 at a predetermined switch-off time 20. In the unregulated secondary side circuit 10 the decreasing current continues to flow until there is no more energy stored in the transformer.

By varying the switch-off time 20 in relation to the point of time where the commutation takes place, it is possible to precisely regulate the output voltage V₀₁ of the first secondary output circuit 5, by regulating the amount of charge that flows to the output capacitor 9. The output voltage V₀₁ can thus be regulated using a PWM control method, as is well known in the art.

FIG. 3 illustrates waveforms in the flyback converter of FIG. 1 in a second situation. From top to bottom there is, again, illustrated the current iₚ of the primary side input circuit 1, the current iₛ₁ of the first secondary output circuit 5, and the current iₛ₂ of the second secondary output circuit 10. FIG. 3 illustrates a case where the desired output voltage V₀₁ is substantially lower than (n1/n2)*V₀₂.

In this case, iₛ₁ rises very fast, due to the voltage difference between the winding 6 and the output capacitor 9. During the interval in which iₛ₁ flows, the voltage across the winding 11 is clamped to (n₂/n₁)*Vₒ₁<<Vₒ₂. Therefore the diode 12 blocks during this interval. This remains until the switch element 8 switches iₛ₁ off. Then a current iₛ₂ begins to flow through the second output circuit 10. The result is thus a second commutation interval, which is undesirable. Moreover, the RMS current in the first output circuit 5 becomes considerably higher, due to the higher peak current, and therefore the dissipation increases. This is due to the fact that energy is transferred sequentially first from the transformer 3 to the first output circuit 5, then from the transformer 3 to the second output circuit 10.

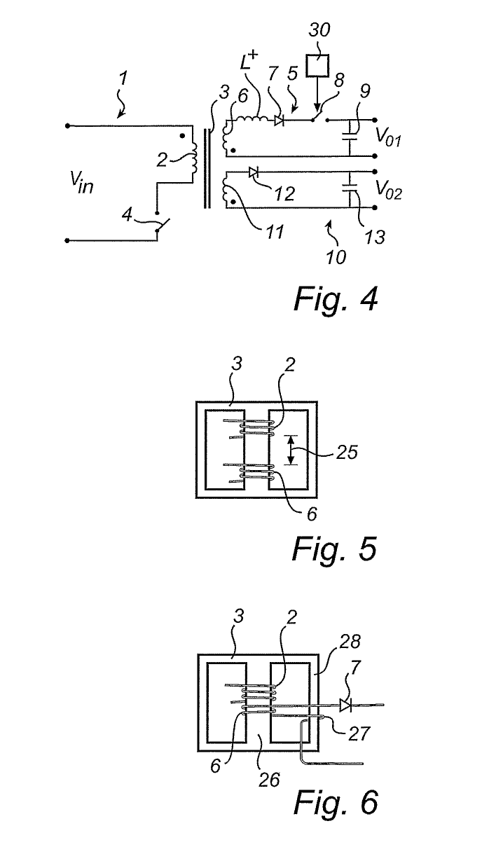

FIG. 4 illustrates a flyback converter, modified in accordance with an embodiment of the invention. The invention relies on the understanding that it is the leakage inductances of the secondary windings 6, 11 that allows the output voltages Vₒ₁, Vₒ₂ to deviate from Vₒ₁*n₂=Vₒ₂*n₁ at all. As will be shown in an example, the converter may comprise more than one output circuit 5, which is regulated on the secondary side.

In order to provide a converter with higher efficiency, the first output circuit 5 should comprise means for increasing its inductance L⁺. With an increased inductance both the rising slope and the peak value of iₛ₁ are lowered. This lowers the RMS value of the current and avoids to a large extent the second commutation. If second commutation is avoided energy is transferred more or less simultaneously from the transformer 3 to the first and second output circuits 5, 10, thus resulting in lower RMS currents.

The value of the increased inductance depends on the application and should be determined experimentally. A too large inductance increase should be avoided, since this leads to a stronger deviation from the output voltage relationship Vₒ₁*n₂=Vₒ₂*n₁. In case Vₒ₂ is the main regulated output, the voltage across winding 6 may then under certain load conditions become lower than the desired Vₒ₁, which means that regulation can no longer be carried out.

There are several methods available for increasing the inductance of the output circuit 5, as will be described later.

The addition of the inductance L+ allows the output voltage Vₒ₁ to be choosen with a greater freedom of choice while still avoiding the undesirable second commutation, provided of course that Vₒ₁≦Vₒ₂*n₁/n₂. In fact, it is even possible to let Vₒ₁ vary during operation of the converter. Then a control circuit 30 regulates Vₒ₁ to different voltages at different occasions during operation. Note however that Vₒ₁ should still not deviate too far from Vₒ₂*n₁/n₂.

It should be understood that the inductance in the first output circuit 5 could preferably be increased by increasing the leakage inductance of the winding 6. There are different ways described in the art for decreasing the leakage inductance in various systems comprising transformers. The leakage inductance can in general be increased by doing the contrary.

FIG. 5 shows an arrangement for increasing the leakage inductance of a winding. In this arrangement, a gap 25 is provided between the primary winding 2 and the first secondary winding 6 on the transformer 3.

FIG. 6 shows another arrangement for increasing the leakage inductance of a winding. The winding is primarily wound around a first leg 26 of a transformer. The leakage inductance is increased by one turn 27 in the winding enclosing a second leg 28 of the transformer. Such windings may be called “half turn” windings, and may be provided in many different ways, an example of which will be given later. As regards the half turn concept in general, reference is made to “How to design a transformer with fractional turns”, Dixon, L. H.; Unitrode Design Seminar; Date of issue: MAG-100A. Of course more than one such turn may be provided.

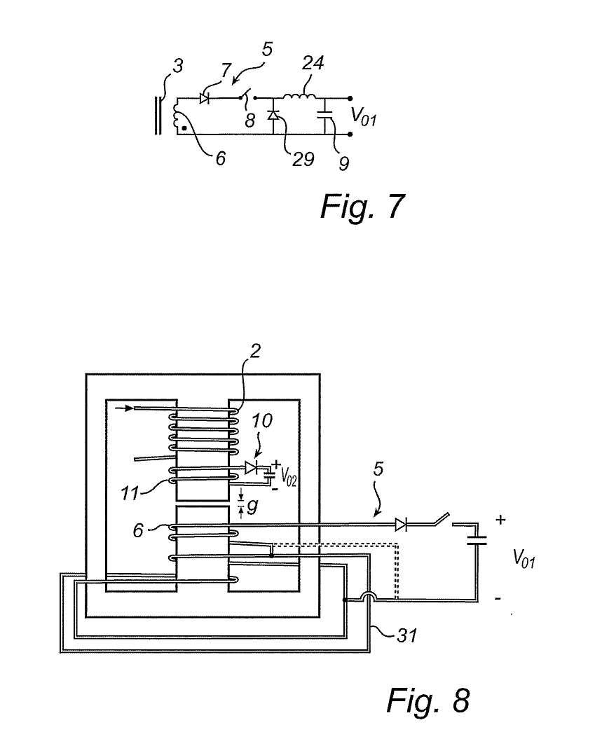

FIG. 7 illustrates an alternative method for increasing the inductance in an output circuit. In this case, instead of increasing the leakage inductance of the winding, an auxiliary inductance 24 is connected in series with the winding 6 via the diode 7 and the secondary side switch 8. A freewheeling diode 29 is also added, allowing a current to continue to flow through the auxiliary inductance 24 when the switch 8 switches off, thus avoiding inductive voltage spikes.

FIGS. 8-14 illustrate experimental results achieved when an embodiment of the present invention is applied.

FIG. 8 illustrates schematically a preferred embodiment of the invention where so called half turns are added to a transformer winding. The transformer 3, comprises an air gap g, and has three windings 2, 6, 11 on its centre leg. One winding 2 forms part of an input circuit, whereas two others 6, 11 form part of a regulated 5 and an unregulated 10 output circuit, respectively, as disclosed earlier in connection with FIG. 4. The loop 31 illustrated in FIG. 8 is equivalent to two parallel half turns, connected in series with winding 6. When in the following given example an “half turn” is applied, the loop 31 is used. In the conventional reference example, the loop 31 is not used (dashed line), and the number of turns is increased in the winding 6 in order to achieve a sufficient voltage.

The following windings are used in the example.

| | | |
|---|---|---|
| Conventional transformer: | 5 V winding: | 3 turns |
| | 3.3 V winding: | 3 turns |
| | 1.8 V winding: | 2 turns |

Therefore, the 3.3V is secondary controlled from a 5V winding voltage, whereas the 1.8V is secondary controlled from a 3.3V winding voltage (2*(5/3)).

| | | | |
|---|---|---|---|
| Half turn transformer: | 5 V winding: | 3 | turns |
| | 3.3 V winding: | 2 + ½ | turns |
| | 1.8 V winding: | 1 + ½ | turns |

The 3.3V is secondary controlled from a 4.16V (2.5*(5/3)) winding voltage, whereas the 1.8V is secondary controlled from a 2.5V winding voltage (1.5*(5/3)).

By application of the half turns, two advantages are achieved. Firstly, the voltage difference between the secondary regulated output Vₒ₁ and the associated transformer winding 6 is limited as compared to the conventional converter transformer. This in it self limits peak currents. Secondly, the leakage inductances are increased due to the half turns.

The reference example has four outputs:

Output 1: 12V 1 A (normal flyback output)

Output 2: 5V 2 A (main regulated output)

Output 3: 3.3V 1 A (secondary regulated output)

Output 4: 1.8V 2 A (secondary regulated output)

Output 1 and 2 thus correspond to examples of the output circuit 10 in FIG. 4, whereas Output 3 and 4 correspond to examples of the output circuit 5 in FIG. 4.

The windings of Output 1 and 2 are fully wound on the centre leg of the transformer 3, together with the primary winding of the input circuit. If a conventional transformer is used (reference example), the windings associated with Output 3 and 4 are wound fully on the centerleg of the transformer. If a half turn transformer is used, the windings associated with these outputs are wound partly on the centerleg and partly on the outer legs of the transformer, as illustrated in FIG. 8.

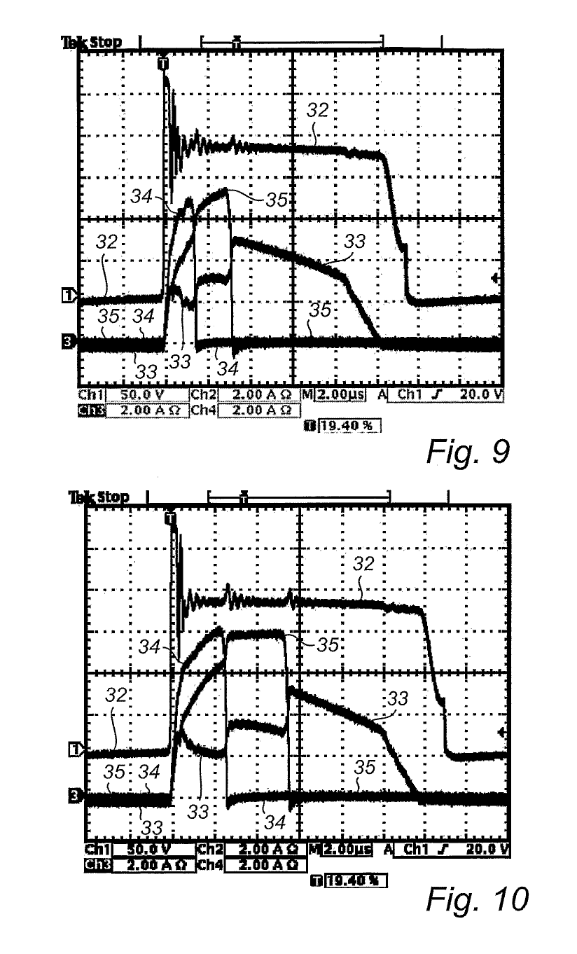

FIGS. 9 and 10 illustrate oscilloscope images for a conventional converter, FIG. 9 at half load (Output 3: 0.5 A; Output 4: 1 A) and FIG. 10 at full load (Output 3: 1 A; Output 4: 2 A). There is illustrated in FIGS. 9 and 10 the primary switch 4 voltage 32, the current through the winding of Output 2, 33, the current through the winding of Output 3, 34, the current through the winding of Output 4, 35. The current of Output 1 is not important in the example.

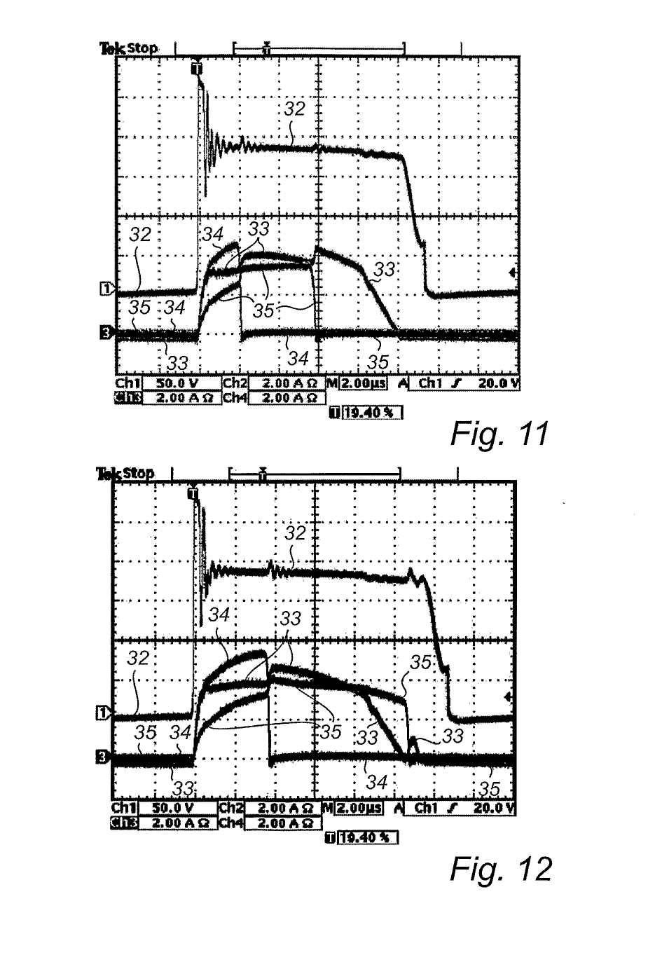

FIGS. 11 and 12 illustrate a corresponding measurement performed on a converter according to an embodiment of the invention, comprising so called half turns for increasing the leakage inductances in the switch regulated output circuits. It should be noted that the peak current 35 of Output circuit 4 is about half of the current of the corresponding conventional circuit. Because of the decreased peak value, the duration of the current pulse becomes longer as to maintain the same output current. As a result, the Output 4 winding RMS current becomes lower, giving less losses in the diode and the switch. The winding current of Output 3 also decreased, but less than a factor 2. Also the slow rise of the Output 4 winding current 35 compared to the rise of the Output 2 winding current 33 should be noted. This is due to the leakage introduced by the half-turn winding. The Output 2 winding is wound on the transformer's centerleg, together with the primary winding, and therefore the leakage associated with the Output 2 winding is lower.

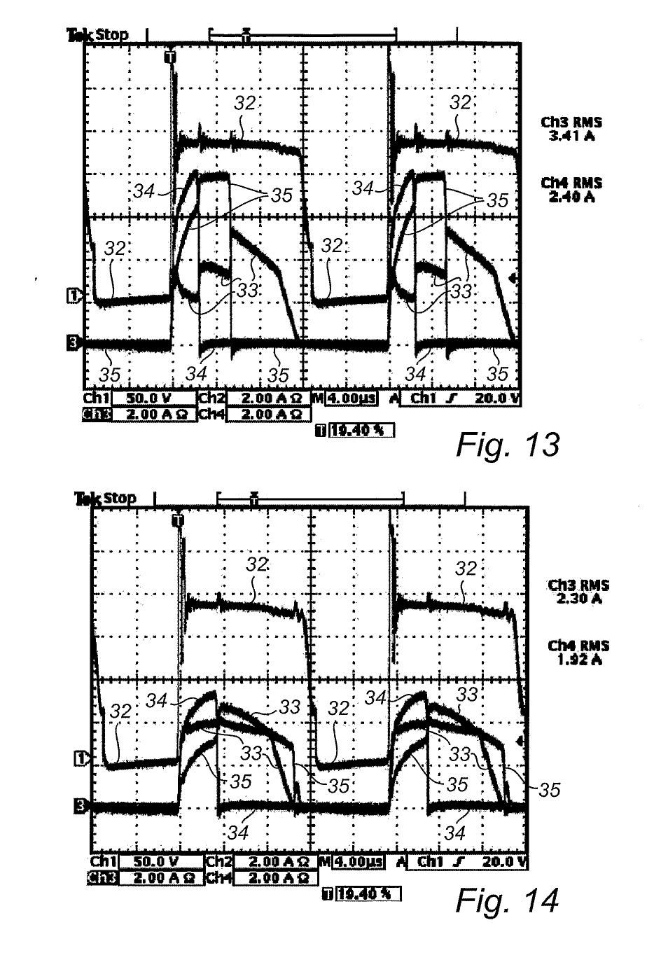

FIGS. 13 and 14 illustrate an RMS current comparison at full load between a conventional converter, FIG. 13, and a converter according to an embodiment of the invention, FIG. 14. As can be seen, the RMS currents, and hence the losses, at Output 3 and 4 become substantially lower. In a typical application, the on-resistance R_{dson} of a MOSFET switch is 140 mΩ (TO220 casing). The losses of such a switch would therefore become the following:

| | | RMS | |
|---|---|---|---|
| Transformer | Output | current | Conduction loss (I²_{RMS}*R_{dson}) |
| conventional | 3 | 2.4 A | 0.81 W |
| | 4 | 3.41 A | 1.63 W |
| half-turn | 3 | 1.92 A | 0.52 W |
| | 4 | 2.3 A | 0.74 W |

In case of the Output 4 circuit, the switch losses are more than halved by the application of the half turn transformer. This means that a heatsink can be saved (1.63 W can hardly be dissipated in the switch without using a heatsink, while 0.74 W poses no problem). In summary, the invention relates to a multiple output flyback converter having a switch regulated output circuit. To avoid a second commutation interval, due to an output voltage in this secondary controlled output that is lower than what is implied by its number of winding turns, the inductance of this circuit is increased. This can preferably be done by increasing the leakage inductance of the winding in the regulated circuit.

The invention is not restricted to the described embodiment. It can be altered in different ways within the scope of the appended claims.

1. A flyback converter, comprising a primary side input circuit (1), having a primary winding (2) wound on a transformer (3) and a primary switch element (4) in series with the primary winding (2), a first output circuit (5), having a first secondary winding (6), wound on the transformer (3) and connected in series with a rectifying element (7) and a secondary switch element (8), and at least a second output circuit (10), having a second secondary winding (11), wound on the transformer (3) and connected in series with a rectifying element (12), wherein said first output circuit (5) comprises means (24; 25; 27; 31) for increasing the inductance in the first output circuit (5).

2. A flyback converter according to claim 1, wherein said means for increasing the inductance in the first secondary output circuit comprises means (25; 27; 31) for increasing the leakage inductance of the first secondary winding (6).

3. A flyback converter according to claim 2, wherein the first secondary winding (6) is primarily wound around a first leg (26) of the transformer (3) and wherein said means for increasing the leakage inductance of the first secondary winding (6) comprises at least one turn (27) in the first secondary winding (6) enclosing a second leg (28) of the transformer (3).

4. A flyback converter according to claim 2, wherein said means for increasing the leakage inductance of the first secondary winding (6) comprises a gap (25) between the primary winding (2) and the first secondary winding (6).

5. A flyback converter according to claim 1, wherein said means for increasing the inductance in the first secondary output circuit (5) comprises an auxiliary inductance (24), connected in series with the first secondary winding, and a freewheeling diode (29), for allowing a current to continue to flow through the auxiliary inductance when the secondary switch (8) is opened.

6. A flyback converter according to claim 1, further comprising control means (30) for variably controlling the output of the first secondary output circuit (5).
